(19) United States
(12) Patent Application Publication
(10) Pub. No.: US 2009/0046988 A1
(43) Pub. Date: Feb. 19, 2009

(54) SYSTEM AND METHOD FOR RECORDING INTERRUPTED BROADCAST OF A MULTIMEDIA PROGRAM

(76) Inventor: Jason B. Kenagy, La Jolla, CA (US)

Correspondence Address: QUALCOMM INCORPORATED, 5775 MOREHOUSE DR., SAN DIEGO, CA, 92121, US

(21) Appl. No.: 11/838,777

(22) Filed: Aug. 14, 2007

(51) Int. Cl. H04N 5/91

(52) U.S. Cl. 386/83

(57) ABSTRACT

An embodiment includes a method of recording a broadcast program. The method includes storing at least a first portion of a program, the program being broadcast during a first period, identifying at least a second portion of the program, identifying a subsequent broadcast of the program during a second period, and storing the subsequent broadcast of the program starting at a position that is based on the second portion. Other aspects include systems, apparatus, and devices for recording multiple portions of a broadcast program during multiple broadcast time periods.

### TECHNICAL FIELD

This application relates generally to communications, and more specifically, to communication of streamed multimedia data.

### BACKGROUND

Mobile devices can provide multiple services for a user. For example, a mobile device may include a telephone, a camera, a PDA and even a multimedia display (e.g., a television). Reception of broadcast data on mobile devices can be interrupted due to signal fading, network overcrowding, loss of power, etc. When a signal is lost, portions of a broadcast signal may be lost. In the case of programs that may be rebroadcast, later rebroadcasts may be difficult to identify or coordinate with a person's schedule. Real-time recording of programs may make for convenient viewing later on, but real-time recordings of broadcast programs are also susceptible to the same interruptions as other forms of mobile communication.

### SUMMARY

Method and apparatuses or devices of the invention each have several aspects, no single one of which is solely responsible for its desirable attributes. Without limiting the scope of this invention, for example, as expressed by the claims which follow, its more prominent features will now be discussed briefly. After considering this discussion, and particularly after reading the section entitled “Detailed Description” one will understand how the features of this invention provide advantages that include allowing a user device to record multiple portions of a broadcast program during multiple time periods.

An embodiment includes a method of recording a broadcast program. The method includes storing at least a first portion of a program, the program being broadcast during a first period, identifying at least a second portion of the program, identifying a subsequent broadcast of the program during a second period, and storing the subsequent broadcast of the program starting at a position that is based on the second portion. Other aspects include systems, apparatus, and devices for recording multiple portions of a broadcast program during multiple broadcast time periods.

### BRIEF DESCRIPTION OF THE DRAWINGS

FIG. 1 is a block diagram illustrating an example system for providing broadcast programming to mobile devices.

FIG. 2 is a block diagram illustrating an example of a mobile device such as illustrated in FIG. 1.

FIG. 3 is a flowchart illustrating an example of a method of recording a broadcast program such as in the example system illustrated in FIG. 1.

FIG. 4 is a flowchart illustrating another example of a method of recording a broadcast program such as in the example system illustrated in FIG. 1.

### DETAILED DESCRIPTION

The following detailed description is directed to certain specific aspects of the invention. However, the invention can be embodied in a multitude of different ways, for example, as defined and covered by the claims. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

As an example of some of the above concepts, if a device is receiving and recording a broadcast multimedia program that a user is watching and a telephone call is received at the same time, the user may interrupt receiving, and thus interrupt recording of, the multimedia program, to answer the phone call. The device could miss a large portion of the program and may need to look for a complete subsequent broadcast in order to obtain a complete recording. Thus, a need exists for alternative methods and apparatuses for providing an efficient way to record broadcasts of a program being broadcast at different times.

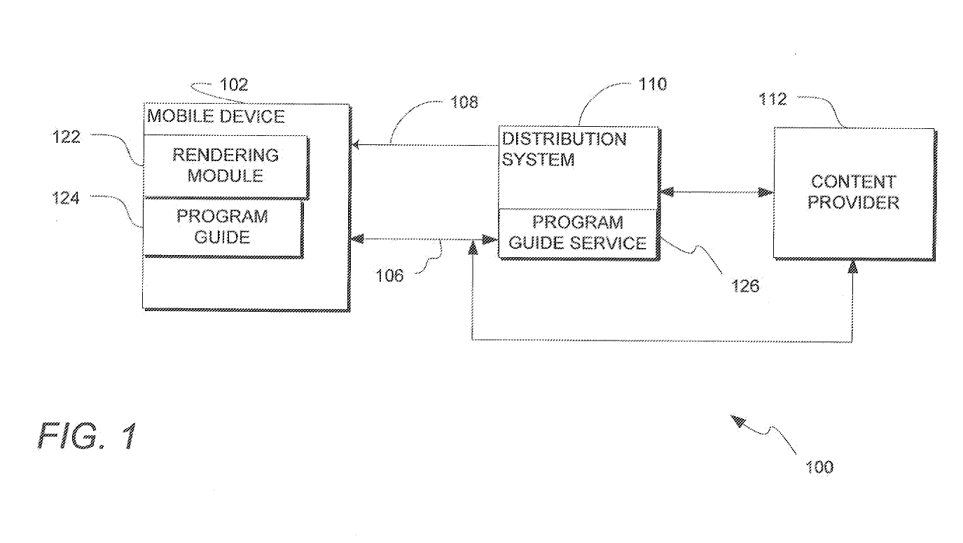

FIG. 1 is a block diagram illustrating an example system 100 for providing broadcast programming to mobile devices 102. While a single mobile device 102 is shown in FIG. 1, examples of the system 100 may be configured to use any number of mobile devices 102. The system 100 also includes a distribution system 110 and a content provider 112. The distribution system 110 may receive data representing a multimedia program from the content provider 112. The multimedia data may be received over a wired or wireless link. The distribution system 100 may then transmit the multimedia data over a broadband communication link 108. In some examples, the content provider 112 may communicate the content directly to the mobile device 102 (not shown in FIG. 1).

In the example system 100, the broadband communication link 108 is depicted as a unidirectional, or at least mostly unidirectional, network. However the communication link 108 may also be a fully symmetric bi-directional network. The communication link 108 may comprise one or more wired and/or wireless links, including one or more of an Ethernet, telephone (e.g., POTS), cable, power-line, and fiber optic systems, and/or a wireless system comprising one or more of a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1xEV-DO or 1xEV-DO Gold Multicast) system, an IEEE 802.11 system, a MediaFLO system, a DMB system, an orthogonal frequency division multiple access (OFDM) system, or a DVB-H system.

The mobile device 102 includes a rendering module 122 configured to render the multimedia programming received over the communication link 108. The rendering module 122 may include analog and/or digital technologies. The rendering module 122 may include one or more multimedia signal processing systems, such as video encoders/decoders, using encoding/decoding methods based on international standards such as MPEG-x and H.26x standards. Such encoding/decoding methods generally are directed towards compressing the multimedia data for transmission and/or storage. Compression is broadly the process of removing redundancy from the data.

In addition to communicating programming content to the mobile device 102, the distribution system 110 may also include a program guide service 126. The program guide service 126 may communicate data representing an electronic programming guide (EPG) 124 to the mobile device 102. The EPG 124 contains data related to the broadcast schedule of multiple programs. The EPG 124 may provide programming and scheduling data for multiple individual channels available to be received over the communication link 108. The EPG data may include titles of programs, start and end times, category classification of programs (e.g., sports, movies, comedy, etc.), quality ratings, adult content ratings, etc. The EPG 124 may also be communicated to the mobile device 102 over the communication link 108 and stored in the mobile device 102.

In the example system 100, the mobile device 102 is also configured to communicate on a second communication link 106. The second communication link 106 is a two way communication link in the example system 100, however, the second communication link 106 could also be a second one way link going from the mobile device 102 to the distribution system 110 and/or the content provider 112. The second communication link 106 may be a wireless network configured to communicate voice traffic and/or data traffic.

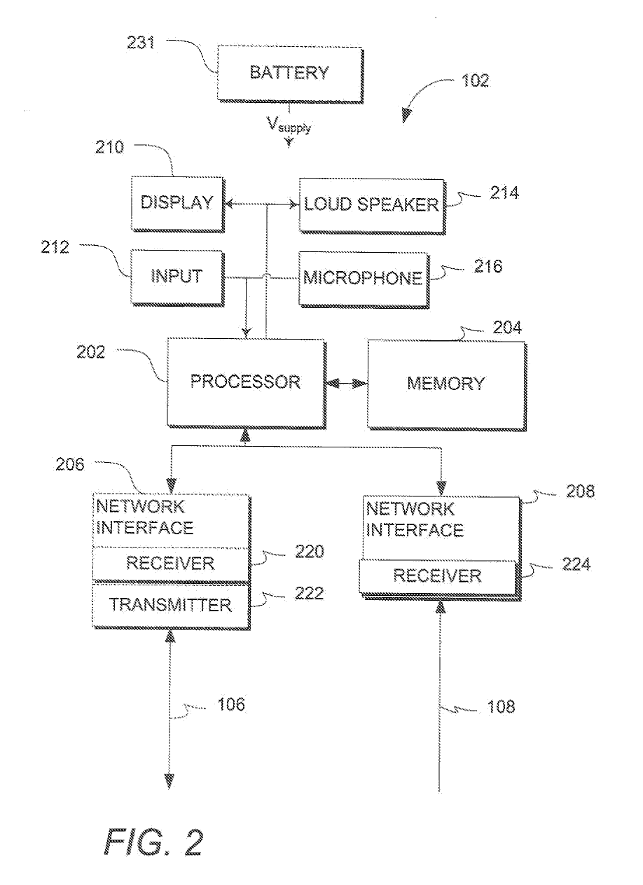

FIG. 2 is a block diagram illustrating an example of the mobile device 102 such as illustrated in FIG. 1. The device 102 includes a processor 202 that is in communication with a storage or memory 204 and a network interface 208 that communicates over the broadband communication link 108. The network interface 208 includes a receiver 224 configured to receive the unidirectional broadband communication link 108. The network interface 208 and receiver 224 may receive signals according to wired technologies including Ethernet, telephone (e.g., POTS), cable, power-line, and fiber optic systems, and/or wireless technologies comprising one or more of a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1xEV-DO or 1xEV-DO Gold Multicast) system, an IEEE 802.11 system, a MediaFLO system, a DMB system, an orthogonal frequency division multiple access (OFDM) system, or a DVB-H system.

The mobile device 102 may include an optional second network interface 206 for communicating via the second bi-directional communication link 106. The network interface 206 may include any suitable antenna (not shown), a receiver 220, and a transmitter 222 so that the exemplary device 102 can communicate with one or more devices over the second communication link 106. Optionally, the network interface 206 may also include processing capabilities to reduce processing requirements of the processor 202.

The device 102 also includes one or more of a display 210, a user input device 212 such as a key, touch screen or other suitable tactile input device, a loudspeaker 214 comprising a transducer adapted to provide audible output based on a signal received over the communication link 106 and/or a microphone 216 comprising a transducer adapted to provide audible input of a signal that may be transmitted over one or both of the communication links 106 and 108.

The device 102 may optionally include a battery 231 to provide power to one or more components of the device 102. The device 102 may comprise at least one of a mobile handset, a personal digital assistant, a laptop computer, a headset, a vehicle hands free device, or any other electronic device. For example, one or more aspects taught herein may be incorporated into a phone (e.g., a cellular phone), a personal data assistant (“PDA”), an entertainment device (e.g., a music or video device), a headset (e.g., headphones, an earpiece, etc.), a microphone, or any other suitable device.

The device 102 may store or record a program being received over the communication link 108 to the memory 204. The memory may comprise volatile memory such as DRAM, or non-volatile memory such as flash memory or disk based storage. The program may be stored in the format in which it was received, or it may be stored in another format (e.g., a compressed format). In one aspect, the display unit may 210 may be used to display the rendered program while the program is being stored. In another aspect the program may be recorded to the memory 204 without it being displayed.

The components described herein may be implemented in a variety of ways. Referring to FIG. 2, the device or apparatus 102 is represented as a series of interrelated functional blocks that may represent functions implemented by, for example the processor 202, software, some combination thereof, or in some other manner as taught herein. For example, the processor 202 may facilitate user input via the input devices 212. Further, the transmitter 222 may comprise a processor for transmitting that provides various functionalities relating to transmitting information to another device 102. The receiver 220 may comprises a processor for receiving that provides various functionality relating to receiving information from another device 102.

The device 102 may be able to receive data concurrently from one or both of the communication links 106 and 108. For example, the processor 202 may be incapable of performing the receiving and/or transmitting functions of the bidirectional network interface 206 at the same time that the broadband unidirectional interface 208 is receiving over the communication link 108. Thus, for example, in one embodiment, reception and recording of a broadcast of a program may be discontinued over the communication link 108 when a signal, e.g., a telephone call for example, is received over the communication link 106.

As noted above, FIG. 2 illustrates that in some aspects these components may be implemented via appropriate processor components. These processor components may in some aspects be implemented, at least in part, using structure as taught herein. In some aspects, a processor may be adapted to implement a portion or all of the functionality of one or more of these components. In some aspects one or more of the components represented by dashed boxes are optional.

In some aspects, the device or apparatus 102 may comprise an integrated circuit. Thus, the integrated circuit may comprise one or more processors that provide the functionality of the processor components illustrated in FIG. 2. For example, in some aspects a single processor may implement the functionality of the illustrated processor components, while in other aspects more than one processor may implement the functionality of the illustrated processor components. In addition, in some aspects the integrated circuit may comprise other types of components that implement some or all of the functionality of the illustrated processor components.

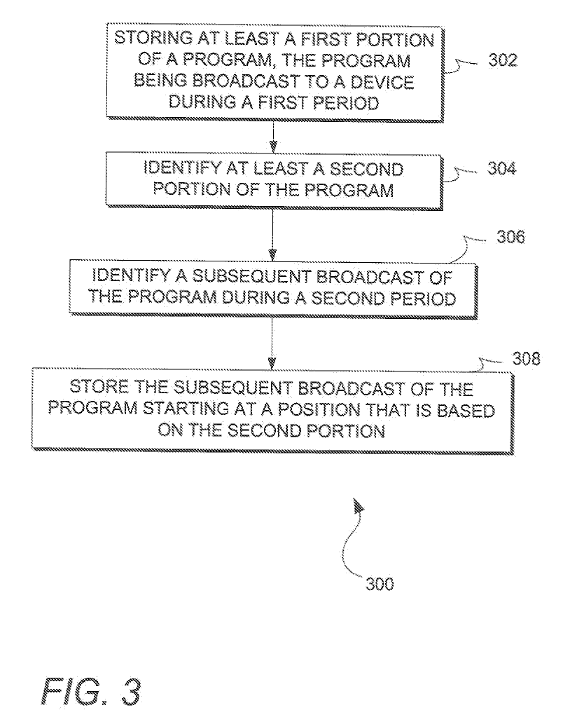

FIG. 3 is a flowchart illustrating an example of a method 300 of recording a broadcast program such as in the example system 100 illustrated in FIG. 1. The acts or events associated with the method 300 may be performed by different types of devices in the system 100. For example, some of the acts or events of the method 300 may be performed by a server such as the distribution system 110, while some of the acts or events may be performed by the mobile device 102 and/or the content provider system 112.

The method 300 is performed while an electronic device, the mobile device 102, for example, is receiving a broadcast program over the communication link 108. While the receiver 224 is receiving the broadcast program, the processor records the program by storing the program into the memory 204 at block 302. At least a first portion of the program is stored to memory at the block 302 during a first period of time that the broadcast is being received. The data being stored to memory at the block 302 may be in a compressed form (e.g., as received encoded in H.26x or MPEGx format). The mobile device 102 may also be displaying the rendered program while it is being recorded.

While the mobile device 102 is recording the program at the block 302, any number of things may interrupt the recording. For example, the optional battery 231 may run low on power and the receiver 224 may be unable to successfully receive the program signal over the communication link 108. In wireless networks, the mobile device 102 may move into an area where the signal strength is insufficient for the receiver 224 to be able to receive the broadcast program. As discussed above in embodiments in which the mobile device 102 comprises a mobile handset, the mobile device 102 may have to interrupt receiving the broadcast program in order to perform another task such as receiving an incoming call or placing an outgoing call. Other reasons for terminating the reception and recording of the program can also be recognized by skilled technologists.

Proceeding to a block 304, the processor 202 identifies a second portion of the program being broadcast. For example, the processor may identify the portion of the program that occurs after or at a specified time proximate to termination of storing the first portion as discussed with reference to block 302. Information identifying the second portion may be stored to the memory 204 at the block 304 in order to identify the second portion later in the process. The information identifying the second portion may be an elapsed time when the program recording was terminated. The information identifying the second portion may be a scene sequence number, a frame number, or some other piece of data identifying a temporal location in the program sequence where the program was terminated. The information identifying the second portion may also include a program identifier such as a title, serial number, or other form of data used to identify the program that was being recorded.

In one aspect, the second portion identified at the block 304 may precede the first portion that was stored at the block 302. For example, if the recording at the block 302 started in the middle of the broadcast program, the second portion identified at the block 304 may be the portion from the beginning of the program to the time at which the recording of first portion was initiated. In addition, multiple second portions may be identified at the block 304 in order to fill in gaps of portions that were recorded previously.

In some examples, the functions performed at the block 304 may be performed by the processor 202 of the mobile device 102. In these examples, the processor 202 may receive a signal, e.g., from the network interface 208, indicative that the program is no longer being received. Knowing when the program started, by using data from an EPG, for example, the processor 202 can determine the elapsed time of the program when the recording at the block 302 was interrupted.

In other examples, the functions performed at the block 304 may be performed by a processor (not shown) of the distribution system 110, and/or the content provider system 112. In these examples, the processor performing the functions may monitor one of the communication links 106 or 108 for a signal from the mobile device 102 indicative that the user is receiving the program. The absence of the signal may be used by the processor to determine that the program could no longer be received due to signal interruption and therefore no longer able to be recorded. Alternatively, the processor may monitor one of the communication links 106 or 108 for a signal indicating that the electronic device has terminated receiving the program and subsequently perform the functions of the block 304. The information identifying the second portion may later be communicated to the mobile device 102.

Moving to a block 306, the processor 202 identifies a subsequent broadcast of the program that is broadcast during a second period of time. The identification of the subsequent program may be performed by searching an EPG for the information identifying the second portion of the program that was determined at the block 304. By using the data identifying the program (e.g., a title, or serial number) that was determined at block 304, an EPG may be used to determine when the program is going to be rebroadcast. This may be done by simply correlating the data obtained at the block 304 with similar data stored in the EPG. Multiple instances of rebroadcasts of the program may also be identified. The functions performed at the block 306 may be performed by the processor 202 of the mobile device 102, or by a processor on the distribution system 110 or the content provider system 112. In the cases where the functions of the block 306 are performed at a device other than the mobile device 102 that is recording the program, the mobile device 102 may be informed of the subsequent program in a message transmitted over one of the communication links 106 or 108. This message may be sent at a predetermined time prior to the start of the second portion that was identified at the block 304 so that the mobile device may restart recording of the program (at block 308 as discussed below) at about the time that the second portion is being rebroadcast.

In one embodiment, the processor 202 automatically identifies a subsequent broadcast based on available broadcasts of the program. In addition, the broadcast may be identified based on other available information such as a schedule or calendar of one or more users of the device 200, and/or viewing time preferences of such users. For example, users may identify time periods during which they prefer to view broadcasts or during which they prefer not to view broadcasts. Additionally, users may specify when they will leave the device in the powered mode, such as when charging the device battery.

In one embodiment, after termination of the first broadcast of the program, a processor 202, e.g., using the display 210, may provide a menu or other user interface having options for a user to identify a subsequent broadcast. For example, in one embodiment, the processor 202 may identify the subsequent broadcasts and provide the user with a menu or other user interface from which to identify a particular subsequent broadcast. In one embodiment, this menu is provided immediately after termination, or after completion of the phone call or another task that terminated the broadcast. In one embodiment, the menu is provided to the user at any later time, e.g., after the processor 202 has correlated the program with the EPG.

Next at a block 308, the processor 202 stores the subsequent broadcast of the program, e.g., to the memory 204 or other storage of the device 100. The storing of the subsequent broadcast may be started at a time based on the information identifying the second portion that was obtained at the block 304. The storing of the subsequent broadcast at the block 308 may be started automatically, or may be started upon receiving an input from the user indicating that the recording of the second portion should be started. When the second portion of the program is being stored at the block 308, the method 300 may treat the recording at the block 308 the same as if it were block 302 and proceed directly to block 304 in the event that the subsequent broadcast is also interrupted, and thereby identify a new second portion to be recorded in yet another rebroadcast. If the rebroadcast of the second portion is stored completely at the block 308, the method 300 may end if all portions of the broadcast program have been stored to the memory 204. If other portions are still missing, and the missing portions have been previously identified at the block 302, the method 300 will continue to identify subsequent broadcasts at the block 306 and storing them at the block 308 until the complete program is stored. Of course, a user may elect to terminate the method 300 at any time (e.g., by using the input device 212) if they decide that they do not want to continue to record the program. In one embodiment, such user termination triggers a request for identifying an additional second portion. Alternatively, the user may select an option to discontinue recording altogether.

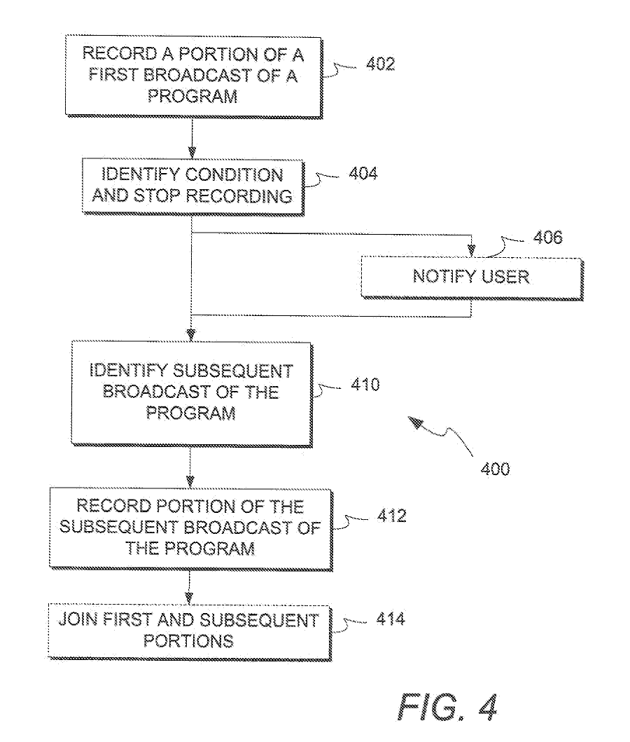

FIG. 4 is a flowchart illustrating another example of a method 400 of recording a broadcast program such as in the example system 100. As discussed above, some conditions, such as loss of the signal of the broadcast, may occur that prevent the complete storing of a first portion of a broadcast program during a first time period. The method 400 starts at block 402, which is similar to block 302 of the method 300, where a portion of a first broadcast program that is being received (e.g., by the receiver 224) is stored to the memory 204. The broadcast portion of the program may be recorded in an uncompressed form such as the form in which it was received over the communication link 108 (e.g., H.26x or MPEG-x encoded data). The recorded data may also be stored in an uncompressed format after rendering by the rendering module 122 or stored in another compressed form. Storing compressed program data allows for less memory to be used to store the recorded program.

If a condition, as discussed above, occurs that causes termination of the recording process, the method 400 proceeds to a block 404 in which the processor 202 identifies condition and stops recording. Such termination conditions identified at the block 404 may include a condition of the mobile device 102 including receiving an incoming telephone call, originating a telephone call running out of battery power, or identifying that the battery 231 is low on power. Termination conditions identified at the block 404 may also include a condition of the communication link 108 over which the program is being received. Conditions related to the communications link 108 may include loss of the signal, or degradation of the signal to a point where the received data has too many errors to be rendered in the decoding process. Wireless networks may be prone to signal fading and low signal strength that depends on the location of the mobile device 102 within a mobile network or depending on the traffic load of the network. Some data-centric networks, for example, may share the channel with various users and may allocate the full bandwidth among several users. If the allocated bandwidth is not sufficient to support a high enough quality video transmission, the user and/or the mobile device 102 may end reception due to a low quality of reception. Other measures indicative of a network related condition may be used as the condition of termination at the block 404. For example, the termination condition may be based on comparing a measured parameter to a specified value, such as, for example a measure of signal strength, bit error rate, frame error rate and/or signal to noise ratio. Upon identifying a termination condition at the block 404, the second portion of the program is identified as discussed above in reference to the block 304 in the method 300.

Next at a block 410, the processor 202 identifies a subsequent broadcast of the program. The identification of the subsequent broadcast may be performed by searching an EPG for the information identifying the second portion of the program that was determined at the block 404. By using the data identifying the program (e.g., a title, or serial number) that was determined at block 404, an EPG may be used to identify when the program is going to be rebroadcast. This may be done by simply correlating the data obtained at the block 404 with similar data stored in the EPG. Multiple instances of rebroadcasts of the program may also be identified. The functions performed at the block 410 may be performed by the processor 202 of the mobile device 102, or by a processor on the distribution system 110 or the content provider system 112. In cases where the functions of the block 410 are performed at a device other than the mobile device 102 that is recording the program, the mobile device 102 may be informed of the subsequent program in a message transmitted over one of the communication links 106 or 108. This message may be sent at a predetermined time prior to the start of the second portion that was identified at the block 404 so that the mobile device 102 may restart recording of the program (at block 412 as discussed below) at about the time that the second portion is being rebroadcast.

Optionally, upon identification of the termination condition at the block 404, the method 400 may proceed to block 406 where the user is notified of the termination condition. The user may be provided with a query asking how to proceed. Choices may include saving the recorded program data and identifying a subsequent program broadcast, or disposing of the incomplete recorded program. If the user chooses to proceed with identifying a subsequent program, the method 400 continues to the block 410 and proceeds as discussed above. If the user chooses not to proceed, the method 400 can end. The notification to the user may be provided by the processor 202 of the mobile device independently, or the mobile device may receive a message over one of the communication links 106 or 108 in cases where the functions at the block 404 are performed by a processor in another device such as the distribution system 110 or the content provider system 112.

Moving to a block 412, the processor 202 records (stores) the subsequent broadcast of the program to the memory 204. The storing of the portion at the block 412 may be started at about the time that the recording of the first portion of the program was terminated at the block 404. As noted above, the program may be stored in a compressed and/or uncompressed state. As discussed above, the recording of the subsequent broadcast of the program may again be interrupted. If so, the method 400 may proceed back to the block 402. This may result in several portions being recorded at different times. The portions need not be recorded in the order in which they occur during the broadcast.

Next at an optional block 414, the first and subsequent portion(s) of the recorded program are joined. The joining of the portions at the block 414 may include appending the second portion to the first portion in the temporal order (as indicated by some time indicia such as elapsed time) in which they are to be played back. For example, if the first portion occurs at the end of the second portion as the program is played, then the recorded first portion will be appended to the end of the second portion in memory. The first and second portions may be joined by storing them into a single file. Overlap between the first and second portions may be identified and removed from the joined recorded program. As those skilled in the art know, joined portions of memory such as a single file need not be located in the same physical part of a memory device such as a disk drive or a flash memory device. Files may be fragmented into various portions of the disk or memory circuitry.

In view of the above, one will appreciate that the disclosure addresses how to record a program by recording a first portion during a first time period and recording a second portion during a subsequent broadcast if the program. For example, the illustrated aspects provide a method and apparatus for recording the second portion during a subsequent broadcast of the program. Also, the illustrated aspects provide a method and apparatus communicating broadcasts to one or more mobile devices and allowing the mobile device to identify a subsequent rebroadcast of the program and record the second portion during the subsequent broadcast.

Any illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Those skilled in the art will recognize that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While the above detailed description has shown, described, and pointed out novel features of the invention as applied to various aspects, it will be understood that various omissions, substitutions, and changes in the form and details of the device or process illustrated may be made by those skilled in the art without departing from the scope of this disclosure. As will be recognized, the invention may be embodied within a form that does not provide all of the features and benefits set forth herein, as some features may be used or practiced separately from others. The scope of this disclosure is defined by the appended claims, the foregoing description, or both. All changes which come within the meaning and range of equivalency of the claims are to be embraced within their scope.

What is claimed is:

1. A method of recording a broadcast program, the method comprising:
storing at least a first portion of a program, the program being broadcast during a first period;
identifying at least a second portion of the program;
identifying a subsequent broadcast of the program during a second period; and
storing the subsequent broadcast of the program starting at a position that is based on the second portion.

2. The method of claim 1, wherein storing the subsequent broadcast of the program comprises joining the first and second portions of the program.

3. The method of claim 2, wherein joining the first and second portions comprises appending the second portion to the first portion to define a program for playback.

4. The method of claim 2, wherein joining the first and second portions comprises storing the first and second portions in a single file.

5. The method of claim 2, wherein joining the first and second portions comprises matching time indicia of the first portion with time indicia of the second portion.

6. The method of claim 1, further comprising receiving the subsequent broadcast on the user device over a wireless channel.

7. The method of claim 6, wherein storing the subsequent broadcast comprises storing the received subsequent broadcast.

8. The method of claim 6, wherein identifying the second portion of the program comprises identifying a condition of the device.

9. The method of claim 8, wherein the condition of the device is based on at least one of a power level, receiving a telephone call, and originating a telephone call.

10. The method of claim 6, wherein identifying the second portion of the program comprises identifying a condition of the wireless channel.

11. The method of claim 10, wherein the condition of the channel is based on at least one of signal fading and low signal strength.

12. The method of claim 10, wherein identifying the condition comprises comparing a specified value to at least one of a signal strength, a bit error rate, a frame error rate, and a signal to noise ratio.

13. The method of claim 1, wherein identifying the subsequent broadcast comprises identifying the subsequent broadcast based on data defining a program guide.

14. The method of claim 13, further comprising receiving a wireless signal indicative of the subsequent broadcast.

15. The method of claim 1, wherein identifying the second portion of the program comprises identifying a temporal location of the first portion.

16. An apparatus for recording broadcast programs, comprising:
a receiver configured to receive broadcasts of a program;
a storage configured to store the program;
a processor configured to:
store at least a first portion of a program to the storage, the program being broadcast during a first period;
identify at least a second portion of the program;
identify a subsequent broadcast of the program during a second period; and
store the subsequent broadcast of the program starting at a position that is based on the second portion.

17. The apparatus of claim 16, wherein the processor is configured to join the first and second portions of the program.

18. The apparatus of claim 18, wherein the processor is configured to join the first and second portions by appending the second portion to the first portion to define a program for playback.

19. The apparatus of claim 18, wherein the processor is configured to join the first and second portions by storing the first and second portions in a single file.

20. The apparatus of claim 18, wherein the processor is configured to match time indicia of the first portion with time indicia of the second portion to join the first and second portions.

21. The apparatus of claim 16, wherein the receiver is configured to receive the broadcast over a wireless channel.

22. The apparatus of claim 21, wherein the processor is configured to store the received broadcast to the storage.

23. The apparatus of claim 21, wherein the processor is further configured to identify a condition of the apparatus and to identify the second portion of the program based on the condition of the apparatus.

24. The apparatus of claim 23, wherein the condition of the apparatus is based on at least one of a power level, receiving a telephone call, and originating a telephone call.

25. The apparatus of claim 21, wherein the processor is further configured to identify a condition of the wireless channel and to identify the second portion of the program based on the condition of the wireless channel.

26. The apparatus of claim 25, wherein the condition of the channel is based on at least one of signal fading and low signal strength.

27. The apparatus of claim 25, wherein the processor is configured to identify the condition of the channel by comparing a specified value to at least one of a signal strength, a bit error rate, a frame error rate, and a signal to noise ratio.

28. The apparatus of claim 16, wherein the processor is configured to identify the subsequent broadcast based on data defining a program guide.

29. The apparatus of claim 28, wherein the receiver is configured to receive a wireless signal indicative of the subsequent broadcast.

30. A computer-program product, comprising:
computer readable medium comprising codes executable by at least one computer to:
receive broadcasts of a program;
store at least a first portion of the program to the storage, the program being broadcast during a first period;
identify at least a second portion of the program;
identify a subsequent broadcast of the program during a second period; and
store the subsequent broadcast of the program starting at a position that is based on the second portion.

31. A device for recording a broadcast program, the device comprising:
means for storing at least a first portion of a program, the program being broadcast during a first period;
means for identifying at least a second portion of the program;
means for identifying a subsequent broadcast of the program during a second period; and
means for storing the subsequent broadcast of the program starting at a position that is based on the second portion.

32. A method of allowing recording of a broadcast program on a user device, the method comprising:
receiving data indicating that a device has stored a first portion of a program, the program being broadcast during a first period;
identifying at least a second portion of the program;
identifying a subsequent broadcast of the program during a second period; and
instructing the device to store the subsequent broadcast of the program starting at a position that is based on the second portion.

33. The method of claim 32, wherein identifying the subsequent broadcast comprises identifying the subsequent broadcast based on data defining a program guide.

34. A computer-program product, comprising:
computer readable medium comprising codes executable by at least one computer to:
receive data indicating that a device has stored a first portion of a program, the program being broadcast during a first period;
identify at least a second portion of the program;
identify a subsequent broadcast of the program during a second period; and
instruct the device to store the subsequent broadcast of the program starting at a position that is based on the second portion.

35. A device for allowing recording of a broadcast program on a user device, the device comprising:
means for receiving data indicating that a device has stored a first portion of a program, the program being broadcast during a first period;
means for identifying at least a second portion of the program;
means for identifying a subsequent broadcast of the program during a second period; and
means for instructing the device to store the subsequent broadcast of the program starting at a position that is based on the second portion.

36. A method of recording a broadcast program, the method comprising:
storing at least a first portion of a program, the program being broadcast during a first period;
identifying at least a second portion of the program;
identifying a subsequent broadcast of the program during a second period; and
storing the subsequent broadcast of the program starting at a position that is based on the second portion.
